(19) United States
(12) Patent Application Publication
(10) Pub. No.: US 2013/0036197 A1
(43) Pub. Date: Feb. 7, 2013

(54) METHOD AND SYSTEM FOR A MOBILE LOCAL SERVER

(71) Applicants: Boris Kai-Tik Chan, Toronto (CA); Sundeep Singh Madra, Palo Alto, CA (US); Jonathan Mikhail, Toronto (CA); David Protasowski, Oshawa (CA); Sina Sojoodi, Toronto (CA); Amar Varma, Toronto (CA)

(72) Inventors: Boris Kai-Tik Chan, Toronto (CA); Sundeep Singh Madra, Palo Alto, CA (US); Jonathan Mikhail, Toronto (CA); David Protasowski, Oshawa (CA); Sina Sojoodi, Toronto (CA); Amar Varma, Toronto (CA)

(73) Assignee: XTREME LABS INC., Toronto (CA)

(21) Appl. No.: 13/565,929

(22) Filed: Aug. 3, 2012

Related U.S. Application Data
(60) Provisional application No. 61/515,671, filed on Aug. 5, 2011.

(51) Int. Cl. G06F 15/16

(52) U.S. Cl. 709/217

(57) ABSTRACT

A method is provided for receiving and rendering web content on a mobile device. Web content is requested from a remote server, and is received on a local server embedded on the mobile device. The content is in a standardized format. The local server then interprets the web content from the standardized format into a format optimized for the mobile device before serving the format-optimized content to an application on the device for rendering. A programmed mobile device for receiving and rendering web content is also provided.

### CROSS REFERENCE TO RELATED APPLICATION

This application claims priority from U.S. Provisional Application No. 61/515,671 filed on Aug. 5, 2011, which is incorporated by reference in its entirety herein.

### TECHNICAL FIELD

The invention relates to methods and systems for rendering content on a mobile device, and more particularly relates to methods and systems for rendering web content.

### BACKGROUND

Web servers are used to transmit web content to clients upon request, which commonly originate from browsers or related applications or systems. A client initiates communication by making a request for resources, particularly pages and embedded elements such as images. The server responds with the content of that resource or an error message if unable to comply or any other errors occur. The client then parses and renders the received resource, if possible.

Although existing in a simple client-server model, web content rendering is complicated in several ways. There are frequently incompatibilities between particular browsers being used to access the content and with the environment in which any particular browser resides. The environment includes the type of device (e.g. a desktop computer, smartphone or other browser capable device). Furthermore, the operating system type and version can also affect rendering, even within the same device. These factors reduce intercompatibility as support for various web standards and protocols is inconsistent. The data carrier may also contribute to the incompatibility issues. For example, some carriers may not permit full HTML5 content by shaping the traffic to disable bandwidth intensive tags such as video.

As a result, web developers must write different code for the various operating systems and versions under which the browser runs in order to provide universal support. This is a cumbersome, time consuming process.

An existing solution is to place proxy servers between the user and web content server. Proxy servers act as intermediaries between clients and servers. One function they may perform is to adapt content for browsers of various operating systems suitable for the requesting client type. However, this solution is not ideal as proxy servers typically are not designed to be scalable to high volume. Further, proxy servers are often used only to help relay content or requests between different parts of a network. Proxy servers are generally not tailored to provide content to specific mobile devices. There may be extensive traffic between a proxy server and the mobile devices it is serving. It would be desirable to provide a method and system for receiving and rendering web content on mobile devices that avoids some of the foregoing limitations.

### SUMMARY

According to a first aspect of the invention, a method is provided for receiving and rendering web content on a mobile device. Web content is requested from a remote server. The web content is received from the remote server on a local server embedded on the mobile device. The web content is in a standardized format. The local server interprets the web content from the standardized format into a format optimized for the mobile device before serving the format-optimized content to an application (such as a browser) on the device for rendering by the application.

When interpreting the web content from the remote server, the local server preferably makes reference to at least one of: an operating system of the device, one or more capabilities of the device, one or more libraries on the device, one or more sensors on the device, a browser type and version on the device, and carrier specifications specific to the device.

In one embodiment, the request is submitted through the application and intermediated through the local server. Alternatively, the local server may retrieve content from the remote server at pre-determined intervals (i.e. available to be served on request).

Preferably, the local server first determines whether the request can be partially or fully handled locally on the device before submitting the request to the remote server. Any parts of the request that can be handled locally are preferably retrieved as components from local sources by the local server.

Prior to sending web content, the remote server may first determine whether the local server is up to date, and if not, may provision an updated local server to the device.

In one embodiment, the local server uses a template for rendering interpreted content.

The local server may use components from diverse sources (e.g. in a template) to generate the format-optimized content for rendering. For example, the local server may couple web content with content retrieved from a local sensor on the device. In another example, the local server may couple the web content with content retrieved from locally stored data.

The standardized format may be a cross-platform format. For example, the remote server may provide the web content to the local server at least in part in XML or SOAP.

Preferably, the format-optimized content interpreted by the local server is at least in part in a markup language (e.g. HTML5).

The local server has several advantages. One is allowing web content to be browsed or interacted with offline (or when limited or no connection is available). Web content is able to be interacted with locally on the device regardless of the connection status of the device. In one embodiment, a user of the device can add to or modify the web content. This added or modified web content can be cached locally by the local server and sent to the remote server on demand or when a connection is available.

According to a second aspect of the invention, a programmed mobile device is provided for receiving and rendering web content from a remote server. The device has a local server module embedded on the mobile device. The module is programmed for (i) requesting web content from the remote server; (ii) receiving web content from the remote server in a standardized format; (iii) interpreting the web content from the standardized format into a format optimized for the mobile device; and (iv) serving the format-optimized web content to an application on the device for rendering.

According to a third aspect of the invention, a programmed mobile device is provided that has a local server module embedded on the mobile device. The device also has at least one application, which is served content from the local server module. At least one device API exposes device settings to the local server, and these device settings are taken into account by the local server module as the local server module serves content to the application. For example, the device settings may include a battery life parameter or a connection parameter.

### BRIEF DESCRIPTION OF THE FIGURES

FIG. 1A is schematic block diagram of an embodiment of the present invention, depicting interaction of components by which a (device-specific) local embedded server can interpret uniform data feed to make it compatible with supported platforms of mobile devices.

FIG. 1B is a simplified schematic block diagram of FIG. 1A, depicting the communications and interactions in the client-server model of the present-invention.

FIG. 2 is a logic flowchart of the how the Local Server is deployed or updated on the client device.

FIG. 3 is a diagram of the notional software stack on a sample mobile device.

### DETAILED DESCRIPTION

The present invention disclosed herein provides methods and systems that mitigate at least some of the disadvantages of current methodology. The present invention overcomes challenges posed by having to develop web sites and applications for each platform while avoiding current network constraints by introducing a more scalable, more carrier independent method and system.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviors that other programming languages might perform during compilation. JavaScript, PHP, Perl, Python and Ruby are examples of dynamic languages. Additionally computer code may also be written using a web programming stack of software, which may mainly be comprised of open source software, usually containing an operating system, Web server, database server, and programming language. LAMP (Linux, Apache, MySQL and PHP) is an example of a well-known open-source Web development platform. Other examples of environments and frameworks using which computer code may also be generated are Ruby on Rails which is based on the Ruby programming language, or node.js which is an event-driven server-side JavaScript environment.

The program code may execute entirely on the client device, partly on the client device, as a stand-alone software package, partly on the client device and partly on a remote computer or entirely on the remote computer or server. In the latter scenario, the remote computer may be connected to the client device through any type of network, including a local area network (LAN) or a wide area network (WAN), or the connection may be made to an external computer (for example, through the Internet using an Internet Service Provider).

It will be understood that the device enables a user to engage with an application using the invention, and includes a memory for storing a control program and data, and a processor (CPU) for executing the control program and for managing the data, which includes user data resident in the memory and includes buffered content. The device may be coupled to an external video display such as a television, monitor, or other type of visual display, in addition to or as an alternative to an onboard display. Storage media may be onboard or external, such as a DVD, a CD, flash memory, USB memory or other type of memory media or it may be downloaded from the Internet. The storage media can be inserted to the device where it is read. The device can then read program instructions stored on the storage media and present a user interface to the user.

In preferred embodiments, the device is fully mobile and portable (e.g. a laptop, a notebook, a cellular phone, a smartphone, a PDA, an iPhone, an iPad, an iPod, an iPad, an e-book reader e.g. Kindle or Kindle DX, Nook, etc.), although it will be appreciated that the method could be applied to more fixed (non-portable) computers and related devices with appropriate modifications (e.g. a personal computer (PC), corporate PC, a server, a PVR, a set-top box, wireless enabled Blu-ray player, a TV, a SmartTV, wireless enabled Internet radio) and other such devices that may be used for the viewing and consumption of content whether the content is local, is generated on demand, is downloaded from a remote server where it exists already or is generated as a result.

In some embodiments, the device has a touch-sensitive display with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. Alternatively, or in addition, one or more buttons, keys, keypads, keyboards, track devices, microphones, etc., and other input mechanisms may be provided.

In some embodiments, the in-built functions may include providing maps and directions, telephoning, video conferencing, e-mailing, instant messaging, blogging, digital photography, digital videoing, web browsing, digital music playing, and/or digital video playing. Instructions for performing these functions may be included in a computer readable storage medium or other computer program product configured for execution by one or more processors.

It should be understood that although the term “application” has been used as an example in this disclosure, in essence the term may also apply to any other piece of software code where the embodiments of the invention are incorporated. The software application can be implemented in a standalone configuration or in combination with other software programs and is not limited to any particular operating system or programming paradigm described here. Thus, this invention intends to cover all applications and user interactions described above as well as those obvious to the ones skilled in the art.

Several exemplary embodiments / implementations of the invention have been included in this disclosure. There may be other methods obvious to persons skilled in the art, and the intent is to cover all such scenarios. The application is not limited to the cited examples, but the intent is to cover all such areas that may be benefit from this invention.

The source device (or server) where content is located or generated and recipient device (or client) where content is consumed may be running any number of different operating systems as diverse as Microsoft Windows family, MacOS, iOS, any variation of Google Android, any variation of Linux or Unix, PalmOS, Symbian OS, Ubuntu or such operating systems used for such devices available in the market today or the ones that will become available as a result of the advancements made in such industries.

The present system and method uses an embedded local server on a mobile device to intermediate a transaction between a requester on the mobile device and a remote data server across a network, and thus reduces the exchange of messages and content between the mobile device and remote servers. This more streamlined approach facilitates application development, particularly for mobile devices and networks, and enables a more consistent user experience of web sites and applications for devices.

Web content is provided by a server that transmits platform-independent content. Instead of being received directly by a browser, the content is processed on a client side embedded local server. This local server then serves content specifically tailored for browsers of that particular platform.

From the viewpoint of content producers and developers, the benefit of this method and system is ensuring that write-once code has a more predictable and intended behavior once rendered by a browser or other application. From the viewpoint of content consumers, user experience is more seamless and error-free, regardless of the device type being used.

Additionally, this method and system of the present invention helps to avoid bottlenecks in the network inherent to current solutions by effectively placing a proxy server directly on the same device as the browser or application making the request. Because the proxy server is on the same device, it is termed a “local” server. Thus the local server has only one client and data traffic is as minimal as possible. Furthermore, the local server type is specific to the client type, which helps to ensure compatibility. The local server also means that content can be cached for offline browsing and/or interaction. The activity does not depend on a continuous data connection of the device. The local server can cache a web page (e.g. a social networking page or profile) which can be added to or modified without a connection (e.g. in a subway or tunnel or on an airplane), and then the added or modified content uploaded to the remote server when the connection is restored (or becomes available). This can also be used selectively to prolong battery life or minimize data charges.

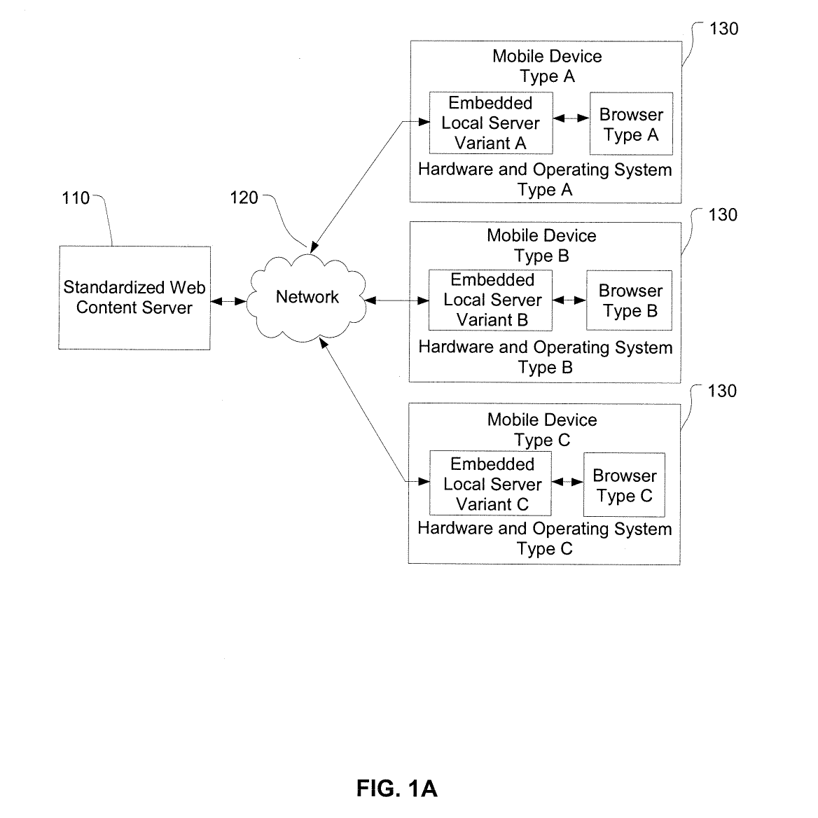

FIG. 1A is schematic block diagram of an embodiment of the present invention, depicting interaction of components by which a (device-specific) local embedded server can interpret uniform data feed to make it compatible with supported platforms of mobile devices.

Referring to FIG. 1A, a remote web content server 110 transmits common instructions via a network 120 to numerous mobile device clients 130 of various supported types. (The remote server 110 also receives data or requests from the clients 130 via network 120.) Each embedded local server is customized to operate with the hardware and software environment (platform) of the device type in which it resides. This local server intermediates transactions between the browser located in the same device and the remote web content server.

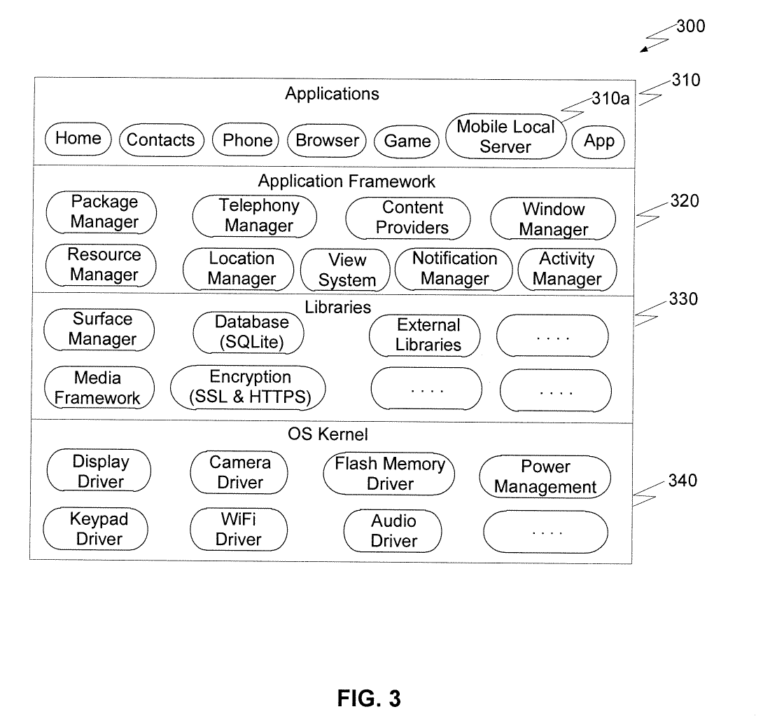

The local server is a library that provides system services to applications such as, but not limited to browsers. As shown in FIG. 3, the mobile local server 310a is situated in the middle of the software stack 300 between applications 310 (such as the browser), and kernel layer components (such as hardware drivers), and adjacent application framework managers 320 and libraries 330. The mobile local server 310a is able to access device resources required for the present invention such as memory, socket listener and data communications such as cellular radio and WiFi. The local server can access device APIs to enable applications on the device to be suitably informed about (and appropriately manage) device parameters such as battery life, connection status, and other resources.

In an embodiment of the process depicted in FIG. 1A, the browser—acting on commands from a user of the mobile device 130 in which it resides—transmits a request to its local embedded server. The local server then forwards the request via the network 120 to the remote web (“cloud”) server 110. When the web server receives the request, it returns instructions to the requesting embedded local server. The instructions are uniform across all platforms. That is, the cloud server 110 sends the same instruction or data to each of the local embedded servers associated with each mobile device, regardless of the device type or platform. The embedded server on the client interprets the instructions in accordance with the characteristics of the platform and makes the resulting (optimized) content available to the browser. The client browser then receives and renders the requested content. The net effect is that the browser or application on a device interacts with its own local embedded server. The local server's secondary interactions with the cloud server are therefore transparent to the end user. That is, the user sees only the rendered content and is unaware of the local server which operates quietly and efficiently in the background.

FIG. 1B is a simplified schematic block diagram of FIG. 1A, depicting the communications and interactions in the client-server model. As shown, local server 150 operates as an intermediary between the remote cloud server 140 and the client 160. Unlike a typical client-server model, part of the server (the “local server”) is present in the client device itself.

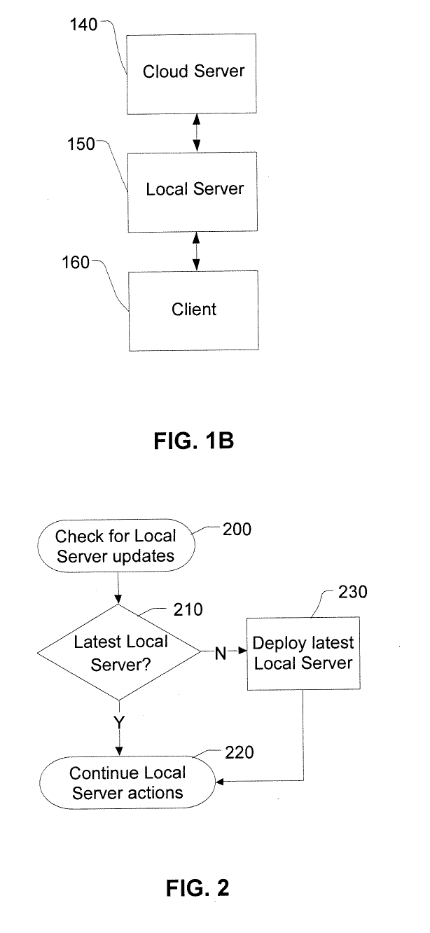

FIG. 2 is a logic flowchart of the how the local server is deployed, updated or maintained on the client device. As shown, the system checks for local server updates 200. A determination is made whether the local server is the latest version 210. If yes, local server actions simply continue 220. If no, the latest local server is deployed 230.

Updates are received from the remote cloud server. When the client makes a request, a handshake occurs. A completed handshake indicates that now the client and server are ready to communicate. Part of the information exchanged is the version of the local server. A different version means that there is a material change in the structure or operation of the local server. Note that the latest version can be downloaded by the client device either as a pull or push process.

Uniform multi-platform instructions from the remote cloud server using protocols such as XML or SOAP are translated by the embedded local server which then provides HTML5 content or other template-based content that is specific to the supported device platform.

Set out below is a basic example of a generic markup converted to HTML or Native. The system can decide at runtime which to use.

Generic markup language:

<view>
<image url=“http://example.com/test.gif” width=320 height=240 />
</view>

Interpreted in HTML/Web:

<body>
<image src=“http://example.com/test.gif” width=320 height=240 />
</body>

Interpreted on Native (iOS):

// read image tag
// create UIImageView
// let canvas be the base UIView
UIImageView *view = [[UIImageView alloc]
initWithURL:@“http://example.com/test.gif”width:320 height:240];
[canvas add:view]; // place in context with the right size;

Hybrid Example

Generic markup Language:

<view>
<image url=“http://example.com/test.gif” width=320 height=240 />
<image url=“http://example.com/test.gif” width=320 height=240
native=“true” />
</view>

Interpreted on Native (iOS):

// fake examples
// read image tag
// create UIImageView
// let canvas be the base UIView
UIImageView *view = [[UIImageView alloc]
initWithURL:@“http://example.com/test.gif”width:320 height:240];
[canvas add:view]; // place in context with the right size;
UIWebView *wView = [[UIWebView alloc] initWithString @“<body>
<image src=“http://example.com/test.gif” width=320 height=240 />
</body>”];
[canvas add:view];

The embedded local server supports bidirectional data push and pull. While constant connection between the remote cloud and local server provides a method for background data exchange, full potential can be realized when it is extended to support bidirectional push and pull between clients via their local servers and the remote cloud server. In this way, it is possible for client devices to host applications for distributed computing such as file sharing, greatly enhancing seamless peer to peer mobile interactions. More advanced interactions and communications are thus enabled. For example, by having a constant/live connection, the local server enables real-time updates, lower bandwidth and latency (as in mobile, the bottleneck in communications from client to server is in latency and the persistent local server avoids the need to redo handshakes, etc.). Further, there is a greater ease of implementing features that require an event-driven model.

Examples of bidirectional content include: templates, data required to render feeds, notifications of events. Specific applications between users can include “Live Drawing” and document collaboration with multiple users.

By having the request intermediated by a local server rather than sent directly to the remote cloud server, it is possible to include more than ordinary browser referrer data (as described for instance at http://en.wikipedia.org/wiki/HTTP_referer, the disclosure of which is incorporated herein by reference) because the local server operates adjacent to the core libraries and kernel. For example, the local embedded server may be able to determine the CPU level of the mobile device or the research usage on the mobile device without the need for a request from the client to the remote cloud server. In this way, traffic or bandwidth usage between the mobile device and the remote server can be reduced. When an embedded local server is employed, the mobile device may not have to make external requests to an external server for content or to employ an external sensor. Generally, by employing an embedded local server, messaging and communication between the mobile device and the external server can be reduced, since the embedded local server helps provide a better understanding of the context in which the mobile device is operating (e.g. using native fonts, or hardware acceleration).

For certain requests which are difficult for a local server with its limited processing and memory resources, tasks may fall back to the cloud server as in the traditional model.

Although still client side activity, this offers improved functionality over browser-side scripting. With typical client-side rendering, the user's request loads the page layout, CSS and JavaScript. Some or all of the content may not be included. Instead, the JavaScript makes another request, gets a response (typically in JSON), and generates the appropriate HTML (e.g. using a templating library). For subsequent updates to the page, the client-side rendering approach repeats the steps it used to get the initial content. Namely, JavaScript is used to get some JSON data and templating is used to create the HTML. Although convenient and quick (Le. bandwidth costs are saved because the skeleton is not heavy, and CPU cycles are saved because the client does all the rendering), this setup is harder to code and more difficult to support multiple or older browsers.

By contrast, with server-side rendering, the user's initial request loads the page, layout, CSS, JavaScript and the content. Although easier to code and more adaptable to older browsers, the cost in bandwidth and CPU cycles is high.

The embedded local server allows for a combination of the advantages of both server-side and client-side rendering while mitigating some of the disadvantages.

In the present invention, the application which is running on the mobile device can either direct requests through the embedded local server or directly to the remote web (cloud) server. In other words, requests do not have to pass through the embedded server (or any other intermediary) but can pass, at the option of the application developer, directly to the remote web (cloud) server. This option could be implemented via program commands employed by the developer.

Particularly, the present invention provides the application developer with the flexibility to determine whether access to content or features (such as sensor access) will occur off-line, i.e. only within the mobile device. Similarly, the present invention provides an application with a more systematic approach to migrate new features to mobile devices. A new feature may initially be deployed as a function (request) within the remote web (cloud) server. As the feature matures, a developer may choose to deploy the function within the version of an embedded local server for a particular type of device. This will avoid the need for requests to the remote web (cloud) server.

Further, the present invention provides the application developer with greater flexibility whether any particular request, on a given type of device, will be handled within the requesting mobile device (for example by accessing locally stored data, or a local sensor—such as an onboard accelerometer), or whether the request will be handled by a request to the remote web (cloud) server.

The intent of the application is to cover all such combinations and permutations not listed here but that are obvious to the ones skilled in the art. The above examples are not intended to be limiting, but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to those familiar with the art.

What is claimed is:

1. A method of receiving and rendering web content on a mobile device, comprising:
requesting web content from a remote server;
receiving web content from the remote server on a local server embedded on the mobile device, the web content being in a standardized format;
the local server interpreting the web content from the standardized format into a format optimized for the mobile device, the local server then serving the format-optimized content to an application on the device; and
the application rendering the format-optimized content on the device.

2. The method of claim 1, wherein the interpreting step makes reference to at least one of the group consisting of an operating system of the device, one or more capabilities of the device, one or more libraries on the device, one or more sensors on the device, a browser type and version on the device, and carrier specifications specific to the device.

3. The method of claim 1, wherein the application is a browser.

4. The method of claim 1, wherein the request is submitted through the application and intermediated through the local server.

5. The method of claim 4, wherein the local server determines whether the request can be partially or fully handled locally on the device before submitting the request to the remote server, wherein any parts of the request that can be handled locally are retrieved as components from local sources by the local server.

6. The method of claim 1, wherein prior to sending web content, the remote server determines whether the local server is up to date, and if not, an updated local server is provisioned to the device.

7. The method of claim 1, wherein the local server uses a template for rendering interpreted content.

8. The method of claim 1, wherein the standardized format is a cross-platform format.

9. The method of claim 1, wherein the web content from the remote server is at least in part in XML or SOAP.

10. The method of claim 1, wherein the format-optimized content is at least in part in a markup language.

11. The method of claim 1, wherein the format-optimized content is at least in part in HTML5.

12. The method of claim 1, wherein the local server couples the web content with content retrieved from a local sensor on the device.

13. The method of claim 1, wherein the local server couples the web content with content retrieved from locally stored data.

14. The method of claim 1, wherein the web content is able to be interacted with locally on the device regardless of the connection status of the device.

15. The method of claim 1, wherein a user of the device can add to or modify the web content.

16. The method of claim 15, wherein the added or modified web content can be cached locally by the local server and sent to the remote server on demand or when a connection is available.

17. A programmed mobile device for receiving and rendering web content from a remote server, comprising:
a local server module embedded on the mobile device programmed for:
requesting web content from the remote server;
receiving web content from the remote server in a standardized format;
interpreting the web content from the standardized format into a format optimized for the mobile device; and
serving the format-optimized web content to an application on the device for rendering.

18. A programmed mobile device, comprising:
a local server module embedded on the mobile device;
at least one application on the device, the application being served content from the local server module; and
at least one device API exposing device settings to the local server, the device settings being taken into account by the local server module as the local server module serves content to the application.

19. The programmed mobile device of claim 18, wherein the device settings comprise at least one of a battery life parameter and a connection parameter.
